(19) United States
(12) Patent Application Publication
(10) Pub. No.: US 2015/0243073 A1
(43) Pub. Date: Aug. 27, 2015

(54) Systems and Methods for Refining an Aerial Image

(71) Applicant: HERE Global B.V., Veldhoven (NL)

(72) Inventors: Xin Chen, Evanston, IL (US); Vladimir Zhukov, Chicago, IL (US)

(73) Assignee: HERE Global B.V., Veldhoven (NL)

(21) Appl. No.: 14/191,698

(22) Filed: Feb. 27, 2014

(51) Int. Cl. G06T 17/05; H04N 5/247; G06T 15/04

(52) U.S. Cl. CPC G06T 17/05; G06T 15/04; H04N 5/247; G06T 2207/30181

(57) ABSTRACT

Systems, apparatuses, and methods are provided for refining an aerial image. A plurality of aerial images is received using a processor. The plurality of aerial images is developed into a three-dimensional model. The three-dimensional model is synthesized into an improved orthophoto image. The improved orthophoto image may be stored on a personal computer or workstation as a reference platform.

### FIELD

The following disclosure relates to orthophotography, satellite imaging, aerial imaging, three-dimensional image reconstruction, computer graphics, and digital mapping. In particular, the following disclosure relates to systems, apparatuses, and methods for refining or reconstructing an aerial image and applying data from the reconstructed image in a reference platform.

### BACKGROUND

Digital representations of the earth's surface—particularly, though not exclusively, in urban areas—are useful in a variety of applications. By way of example, representative applications of orthophotographic city models include, but are not limited to, navigation systems, intelligent transportation systems, urban planning, enhanced city visualization (e.g., virtual tours, tourism), noise modeling, thermographic building inspections, and the like.

A conventional orthophoto typically alters an aerial image by removing the relief displacement of the terrain within the aerial image, wherein, for example, hills and valleys will appear in their true location. Relief displacement of flagpoles, buildings, trees, and other similar features will remain on the image since the top and bottom of the objects occupy the same X and Y coordinate on the ground. This artifact of relief displacement can cause some image distortions or illusions, particularly along a joint between orthophoto sheets. The ambiguity of an object's location due to relief displacement and the spatial resolution of the image both degrade the accuracy in digital mapping. Therefore, providing improved methods for refining aerial images for digital mapping is an ongoing effort.

### SUMMARY

Systems, apparatuses, and methods are provided for an aerial image and applying data from the refined image in a reference platform. In one embodiment, the method comprises receiving, using a processor, a plurality of aerial images. The method further comprises developing a three-dimensional model from the plurality of aerial images. The method further comprises synthesizing an improved orthophoto image from the three-dimensional model.

In another embodiment, the method receiving, using a processor, a plurality of aerial images, wherein the plurality of aerial images has been captured by a plane having a plurality of cameras, with one camera of the plurality of cameras arranged to capture a top-down aerial image. The method further comprises developing a three-dimensional model from the plurality of aerial images, wherein the three-dimensional model is developed through texture mapping, wherein image data from the one camera arranged to capture the top-down aerial image is primarily used in the texture mapping. The method further comprises synthesizing an improved orthophoto image from the three-dimensional model using OpenGL, wherein the improved orthophoto image has a pixel resolution of between 1 cm²/pixel and 20 cm²/pixel. The method further comprises applying the improved orthophoto image to at least one additional data source, thereby improving the spatial alignment in the at least one additional data source.

In one embodiment, the apparatus comprises at least one processor and at least one memory including computer program code for one or more programs; the at least one memory and the computer program code configured to, with the at least one processor, cause the apparatus to at least perform: (1) receive a plurality of aerial images; (2) develop a three-dimensional model from the plurality of aerial images; and (3) synthesize an improved orthophoto image from the three-dimensional model.

### BRIEF DESCRIPTION OF THE DRAWINGS

Exemplary embodiments are described herein with reference to the following drawings.

FIG. 1 illustrates an example of a conventional satellite photograph.

FIG. 2 illustrates an example of a reconstructed, improved orthophoto.

FIG. 3 illustrates an example flowchart for reconstructing an aerial image.

FIG. 4 illustrates an example system of an aerial reconstruction and mapping system.

FIG. 5 illustrates an exemplary mobile device of the system of FIG. 4.

FIG. 6 illustrates an exemplary server of the system of FIG. 4.

### DETAILED DESCRIPTION

The following embodiments include the systems, apparatuses, and methods for refining an aerial image. Analysis techniques and computer algorithms may be used for synthesizing an improved or “true” orthophotograph, or orthophoto. In particular, the following embodiments allow for developing an orthophoto having improved resolution and/or improved spatial or “ground truth” accuracy over a conventional orthophoto. Through development of an improved, high resolution orthophoto, a reference platform may be developed for aligning at least one data source, or in some cases, a plurality of data sources (i.e., two or more data sources). For example, the reference platform may be useful for digital mapping, etc., providing users with increased accuracy and detail and overcoming technical limitations relating to relief displacement, lens distortion, spatial precision, and/or level of accuracy.

As used herein, an “orthophotograph” or “orthophoto” may refer to an aerial photograph that has been geometrically corrected or rectified, such that the scale is uniform (e.g., the photo has the same lack of distortion as a conventional map). Additionally, an orthophoto typically provides a “top-down” view, wherein the viewing direction would be 90 degrees or perpendicular to a street level or ground view. In other words, the top-down view may represent a view of the x-y plane from the z-axis, where the z-coordinate may be attributed to the vertical dimension and the x- and y-coordinates attributed to the horizontal, street level plane. Unlike an uncorrected aerial photograph, an orthophotograph can be used to measure true distances, because it is an accurate representation of the Earth's surface. An orthophoto may be used as a backcover to digitize a road network or other advanced attributes such as buildings. Orthophotos may be referenced as a “ground truth” for aligning a plurality of data sources.

As used herein, the term “ground truth” may refer to a process in which a pixel on an aerial or satellite image is compared to what is there in reality in order to verify the contents of the pixel on the image. Ground truth allows image data to be related to real features and materials on the ground, enabling the calibration of remote-sensing data or the interpretation and analysis of what is being sensed. Ground truth may also assist in correcting distortions in aerial or satellite images.

In certain embodiments, systems, apparatuses, and methods for synthesizing a true orthophoto for use in a reference platform may include processes for: (1) retrieving a plurality of aerial images, (2) reconstructing a three-dimensional (3D) model from the plurality of aerial images, (3) rendering an improved or true orthophoto from the 3D model, and (4) storing the improved orthophoto on a personal computer or network for development of a reference platform. This process may provide higher resolution orthophotos with improved spatial accuracy over conventional orthophotos, allowing for an improved digital map that provides users with increased accuracy and detail and overcomes current technical limitations relating to image resolution or spatial precision, relief displacement, lens distortion, accuracy, and/or lack of high quality ground truth.

For example, the improved, higher resolution orthophoto may create a digital map that allows for accurate automatic feature extraction (e.g., automatic detection of roads and buildings). The improved process also may eliminate issues with relief displacement as the process may use parallel orthographic projections to create the orthophoto from 3D photo mesh. Similarly, lens distortion is not an issue because there is no lens involved in the rendering process.

### Image Collection and Retrieval

In certain embodiments, the process of developing an improved orthophoto includes retrieving a plurality of aerial or satellite images for processing. Unless otherwise specified in this disclosure, the term “aerial image” will refer to both aerial and satellite images. The number of aerial images required for retrieval may depend on the size of the area being developed for the improved orthophoto and/or the resolution of the aerial image being captured. Aerial images are typically captured by at least one camera on an airplane flying hundreds or thousands of meters above the earth's surface, while satellite images are typically captured by a camera on a satellite orbiting several hundred kilometers above the earth's surface. In certain embodiments, the aerial images are captured using multiple cameras mounted on a single airplane. The cameras may be mounted wherein at least one camera is arranged to collect a top-down view of the ground image, and the remaining cameras are arranged to collect oblique or angled views of the ground image. In such embodiments, where 90 degrees defines a top-down view and 0 degrees and 180 degrees define horizontal views in opposing directions, an oblique or angled camera arrangement may be, in certain embodiments, at some degree between approximately 45 and 90 or between approximately 90 and 135 degrees. In some embodiments, cameras may be arranged at oblique or angled views of approximately 45 degrees, 60 degrees, 75 degrees, 105 degrees, 120 degrees, and/or 135 degrees.

In some embodiments, the aerial images are captured using at least five cameras mounted on a single plane. The cameras may be arranged wherein one camera is arranged to collect a top-down view at approximately 90 degrees, and four additional cameras are arranged to collect oblique or angled views at approximately 45 degrees, 60 degrees, 120 degrees, and 135 degrees.

In certain embodiments, the captured aerial images and their metadata are stored in a database for future retrieval and development. The metadata captured by the camera may be Exchangeable Image File Format (EXIF) data, International Press Telecommunications Council (IPTC) data, or Extensible Metadata Platform (XMP) data. The metadata may comprise shutter speed, f-stop, the time the image was captured, the camera model, and/or GPS data. In certain embodiments, the aerial images may include metadata to correlate the images with their geographic locations as determined by its Global Positioning System (GPS), Global Navigation Satellite System (GLONASS), or a similar position sensor for providing location data. Geographic location of buildings within the aerial images may be individually aligned with their respective base or ground-level building footprints, having known global positioning locations.

Spatial precision of the aerial images may depend on the altitude of the flight and camera resolution during aerial photo collection. In certain embodiments, the aerial image may comprise a pixel resolution of approximately 20 cm²/pixel, 10 cm²/pixel, 5 cm²/pixel, or 1 cm²/pixel. In other embodiments, the pixel resolution is between 1-20 cm²/pixel, between 1-10 cm²/pixel, or between 1-5 cm²/pixel.

### Development of 3D Model

After the plurality of aerial images are captured and stored, processing of the plurality of aerial images includes retrieving the captured aerial images and metadata from a database for reconstruction of a 3D model. The 3D model may be reconstructed through development of a 3D point cloud from the aerial images, mesh creation from the point cloud, and texture mapping of the mesh.

Through use of the multiple aerial images and corresponding metadata of the scene, and the metadata for those images, a 3D point cloud may be developed. Through a development of multiple of triangulations of elements, a 3D mesh is formed. A final photo mesh may be formed by combining the 3D mesh data and projecting an image.

In certain embodiments, texture mapping completes the development of the 3D model by applying texture (e.g., color) from the original aerial photographs to the 3D mesh. This may comprise projecting texture onto the mesh randomly, through approaches of combining the textures for super resolution and finally to segmenting the mesh by material, such as specula and diffuse properties. In one particular embodiment, the texture mapping comprises projecting texture onto the mesh primarily associated with the original aerial photograph taken at the top-down view. In this embodiment, in the processing step, an algorithm may analyze the texture or data associated with the multiple cameras and use the top-down camera data, if available, overriding corresponding or similar data collected from one or more of the oblique or angled cameras. The resulting 3D model may comprise data including individual color voxels having x, y, and z coordinates.

The reconstructed 3D model and its correlated data may be stored in the database in any number of file formats, including JPEG, EXTIF, TIFF, RAW, GIF, BMP, PNG, or OBJ files. In certain embodiments, the 3D model includes a combination of standard OBJ files and JPEG files. For example, photo mesh data may be stored in a standard OBJ file and its corresponding tiled textures stored in JPEG files.

### Synthesis of Improved Orthophoto Image

An improved or true orthophoto image may be developed from the generated 3D model, wherein the 3D model is adjusted to provide a top-down or perpendicular image of the ground. An alignment algorithm may be performed to provide a perpendicular image based on the perceived orientation of the captured image in relation to the ground.

The 3D model may be input into an application programming interface (API) that interacts with a graphics processing unit (GPU) on a personal computer or workstation. In one example, the API is OpenGL. In certain embodiments, the input data is stored in standard OBJ files, which may be read in as OpenGL vertex arrays. Corresponding tiled textures may be in form of standard JPEG files and read in as a texture array. In other embodiments, the 3D model generates an improved orthophoto image using shaders, such as OpenGL Shading Language (GLSL).

In certain embodiments, creation of a synthesized top-down aerial image may be done by “rotating” the captured 3D model by using the individual color voxels having the x, y, and z coordinates. In other words, the top-down view may represent a view of the x-y plane from the z-axis. In certain embodiments, the rendered 3D model may be projected onto the aerial 2D image through a matrix transformation. For example, the projection position of a 3D point (x,y,z) within the model may be obtained as follows:

2D_Position=ProjectionMatrix*ViewMatrix*ModelMatrix*[x,y,z,1]

By setting ProjectionMatrix properly, an improved orthophoto image of the scene can be generated as needed. In certain embodiments, the improved orthophoto image comprises a higher resolution over conventional orthophoto images. For example, in some embodiments, the 2D image comprises a pixel resolution of approximately 20 cm²/pixel, 10 cm²/pixel, 5 cm²/pixel, or 1 cm²/pixel. In other embodiments, the pixel resolution is between 1-20 cm²/pixel, between 1-10 cm²/pixel, or between 1-5 cm²/pixel. At these resolutions, requirements may be met for developing the image for advanced digital mapping projections, such as Highly Autonomous Driving (HAD).

### Storage of Improved Orthophoto Image

After the top-down view is created, a screen shot of the improved orthophoto image may be recorded or saved. In certain embodiments, the improved orthophoto image is stored in a database for future retrieval and use in a reference platform. In certain embodiments, the improved orthophoto image is stored in standard PNG format with RGB channels.

In some embodiments, one improved orthophoto image encompasses an entire city, or at least the entire downtown area of a city. For example, one improved orthophoto image may encompass an area of approximately 100 m², 500 m², 1 km², 5 km², 10 km², or 20 km². In other embodiments, multiple improved orthophoto images are combined together to form one image for the entire area of a city. In some embodiments, the size of the file of the improved orthophoto image for an entire city is less than or approximately 100 gigabytes (GB), 500 GB, 1 terabyte (TB), 2 TB, 5 TB, or 10 TB. Based on this size, the orthophoto image may be stored locally on a personal computer or workstation for use in a reference platform.

In some embodiments, the improved orthophoto image may have a pixel resolution of upwards of 7068×7068. The resolution limit may vary based on the input and output data size. Higher resolution may be achieved by advancements in storage, camera resolutions, and the input/output data sizes.

### Use in Reference Platform or Backcover

After storing the improved orthophoto, the orthophoto may be used as a reference platform (or ground truth) or backcover, as the resolution and spatial accuracy of the improved orthophoto may be superior to conventional satellite orthophoto. The improved orthophoto may also outperform ground level data collection because GPS positioning is typically more accurate and there is no inertial measurement unit (IMU) drift in the rendering process. Furthermore, because the resolution of the orthophoto is high enough, the improved orthophoto resolution enables many automatic feature extractions using computer vision. For example, road and buildings can be automatically extracted.

In certain embodiments, the reference platform may be used for improving digital mapping through improved spatial alignment. For example, the improved orthophoto may assist in aligning a plurality of data sources to the improved orthophoto reference platform to improve digital map platforms. In other embodiments, the improved orthophoto may be used in surveying or department of transportation mapping platforms.

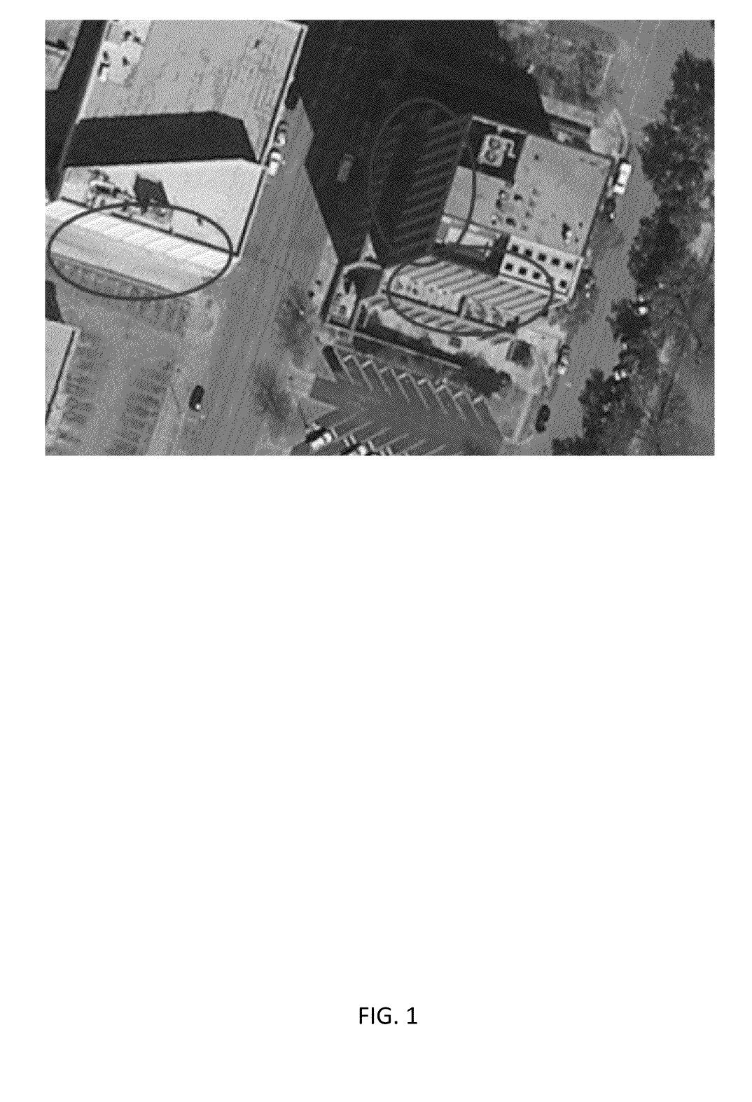

FIG. 1 illustrates a conventional satellite view of two buildings in downtown Austin, Tex. Use of a conventional satellite or aerial image may cause ambiguity of representing the locations of the buildings, as shown by the highlighting circles and relief displacement of the buildings.

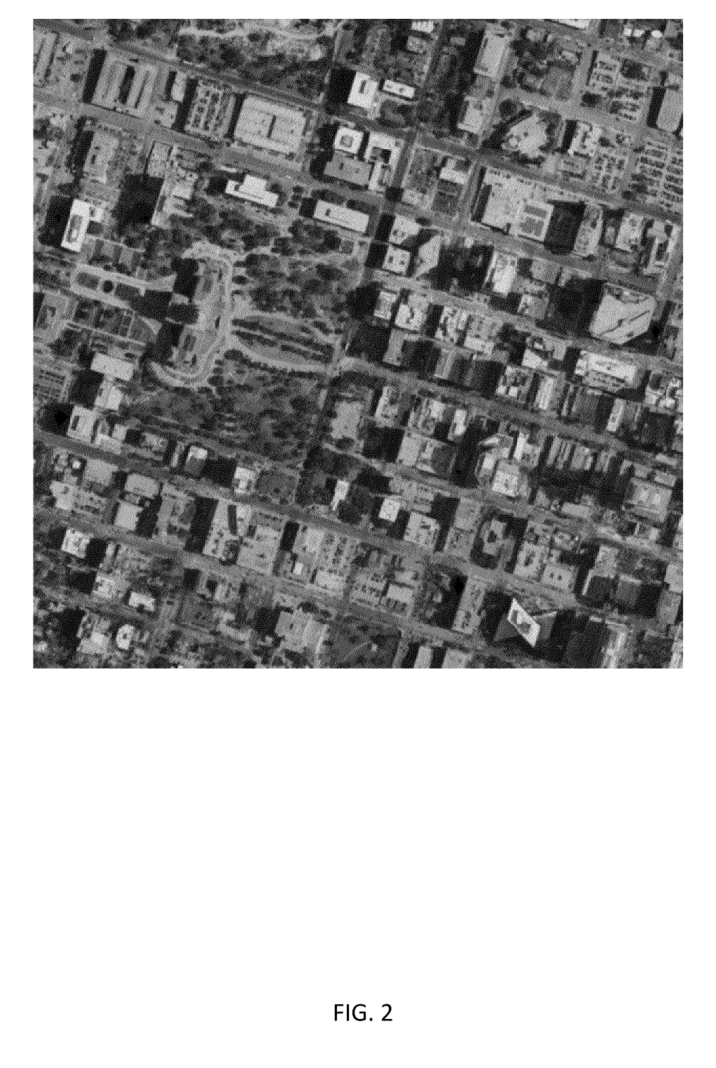

FIG. 2 illustrates one embodiment of an improved orthophoto. As shown in FIG. 2, there are almost no visible building facades or unnecessary relief displacement due to the orthographic parallel projection of the 3D photo mesh according to the process described herein.

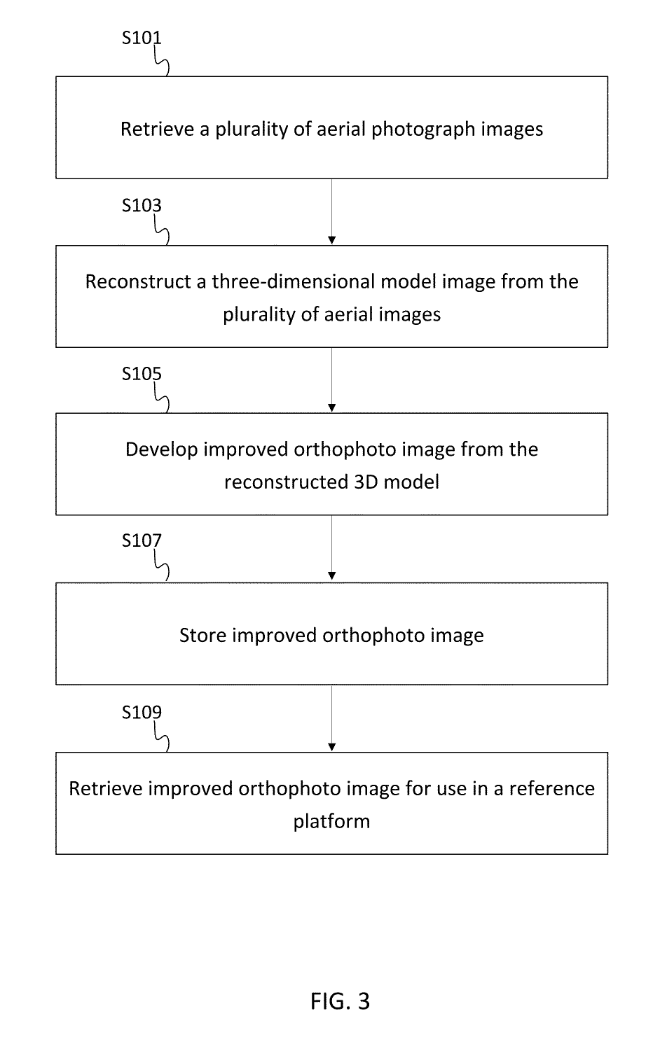

FIG. 3 illustrates an example flowchart for refining building alignment in an aerial image. The process of the flowchart may be performed by a mobile device, personal computer, or workstation, and controller and/or server and processor. Alternatively, another device may be configured to perform one or more of the following acts. Additional, fewer, or different acts may be included.

At act S101, a processor retrieves a plurality of aerial photographs or images for development. The aerial images may also be correlated with their geographic location as determined by GPS, GLONASS, etc.

At act S103, a processor is used to synthesize a 3D model of the plurality of aerial images. In one particular embodiment, synthesis of the 3D model includes texture mapping comprising projecting texture primarily associated with the original aerial photograph taken at the top-down view. In this embodiment, in the processing step, an algorithm may analyze the texture or data associated with the multiple cameras and use the top-down camera data, if available, overriding corresponding or similar data collected from one or more of the oblique or angled cameras. The resulting 3D model may comprise data including individual color voxels having x, y, and z coordinates.

At act S105, an improved orthophoto image is developed from the reconstructed or synthesized 3D model using an API, wherein the 3D model is adjusted to provide a top-down or perpendicular image of the ground. In certain embodiments, the API is OpenGL. In some embodiments, the 3D model generates the improved orthophoto image using shaders, such as OpenGL Shading Language (GLSL). An alignment algorithm may be performed to provide a perpendicular image based on the perceived orientation of the captured image in relation to the ground. In certain embodiments, the rendered model may be projected onto the aerial 2D image through a matrix transformation.

At act S107, the improved orthophoto image is captured and stored for future use. For example, a screen shot of the improved orthophoto image may be saved. In certain embodiments, the improved orthophoto image is stored in standard PNG format with RGB channels.

At act S109, the stored improved orthophoto is retrieved for use in a reference platform or ground truth to align at least one data source. In certain embodiments, the reference platform may be used for improving digital mapping. For example, the improved orthophoto may assist in aligning all data sources to the map platform for digital map making and presentation. In other embodiments, the improved orthophoto may be used in surveying or department of transportation mapping platforms.

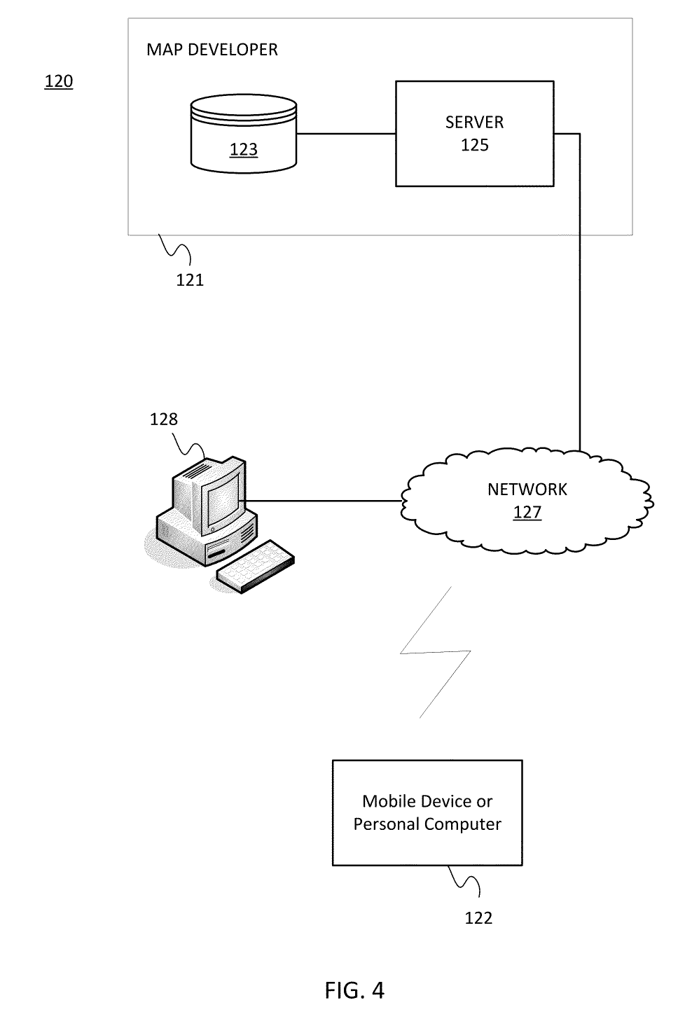

As discussed above, refining or reconstructing an aerial image may be performed by a mobile device, personal computer, or workstation and controller and/or server and processor. FIG. 4 illustrates one embodiment of an aerial image refining system 120. The system 120 may include a map developer system 121, a mobile device or personal computer 122, a workstation 128, and a network 127. Additional, different, or fewer components may be provided.

The mobile device or personal computer 122 may be a smart phone, a mobile phone, a personal digital assistant (“PDA”), a tablet computer, a notebook computer, a desktop computer, a personal navigation device (“PND”), a portable navigation device, and/or any other known or later developed mobile device or personal computer.

The developer system 121 includes a server 125 and a database 123. The developer system 121 may include computer systems and networks of a system operator such as HERE, NAVTEQ, or Nokia Corporation. The database 123 is configured to store aerial images provided from an aerial camera or satellite camera, as well as reconstructed orthophoto images processed by the server and algorithm. The server 125 is configured to receive the plurality of aerial images from the aerial camera or satellite camera and analyze/process the images to form a refined or reconstructed orthophoto image. The server 125 may also be configured to store the 3D model and/or the improved orthophoto image generated in the process.

The developer system 121, the workstation 128, and the mobile device or personal computer 122 are coupled with the network 127. The phrase “coupled with” is defined to mean directly connected to or indirectly connected through one or more intermediate components. Such intermediate components may include hardware and/or software-based components.

The workstation 128 may be a general purpose computer including programming specialized for providing input to the server 125. For example, the workstation 128 may provide settings for the server 125. The settings may include a value for the predetermined interval that the server 125 requests mobile device 122 to relay current geographic locations. The workstation 128 may be used to enter data indicative of GPS accuracy to the database 123. The workstation 128 may include at least a memory, a processor, and a communication interface.

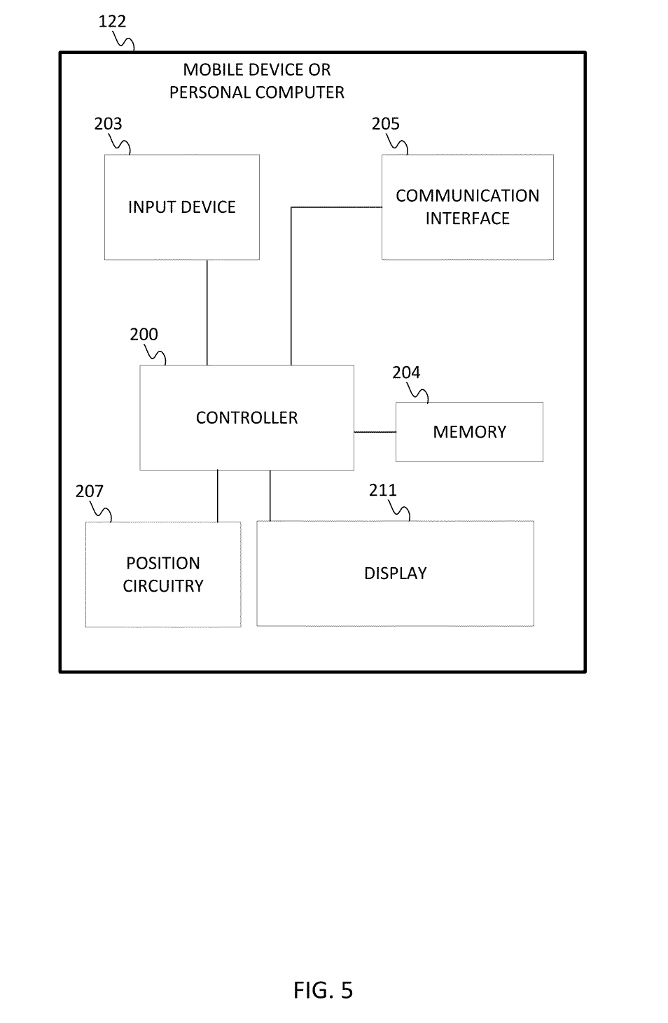

FIG. 5 illustrates an exemplary mobile device or personal computer 122 of the system of FIG. 4. The mobile device or personal computer 122 includes a controller 200, a memory 204, an input device 203, a communication interface 205, position circuitry 207, and a display 211. Additional, different, or fewer components are possible for the mobile device/personal computer 122.

The controller 200 may be configured to receive data indicative of the location of the mobile device or personal computer 122 from the position circuitry 207. The positioning circuitry 207, which is an example of a positioning system, is configured to determine a geographic position of the mobile device or personal computer 122. The positioning system may also include a receiver and correlation chip to obtain a GPS signal. The positioning circuitry may include an identifier of a model of the positioning circuitry 207. The controller 200 may access the identifier and query a database or a website to retrieve the accuracy of the positioning circuitry 207 based on the identifier. The positioning circuitry 207 may include a memory or setting indicative of the accuracy of the positioning circuitry.

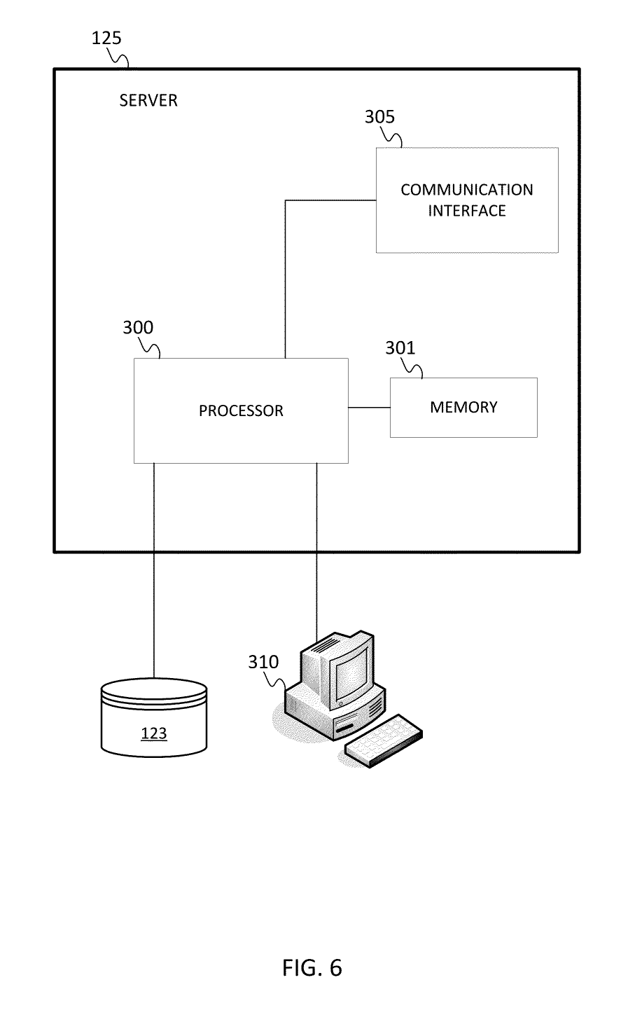

FIG. 6 illustrates an exemplary server 125 of the aerial image refining system of FIG. 4. The server 125 includes a processor 300, a communication interface 305, and a memory 301. The server 125 may be coupled to a database 123 and a workstation 128. The workstation 128 may be used as an input device for the server 125. In addition, the communication interface 305 is an input device for the server 125. The communication interface 305 receives data indicative of use inputs made via the workstation 128 or the mobile device or personal computer 122.

The controller 200 and/or processor 300 may include a general processor, digital signal processor, an application specific integrated circuit (ASIC), field programmable gate array (FPGA), analog circuit, digital circuit, combinations thereof, or other now known or later developed processor. The controller 200 and/or processor 300 may be a single device or combinations of devices, such as associated with a network, distributed processing, or cloud computing.

The controller 200 and/or processor 300 may also be configured to cause an apparatus to at least perform at least one of the aerial image refining methods described above. For example, the controller 200 and/or processor 300 may be configured to perform the process: (1) receive a plurality of aerial images having aerial image data; (2) develop a three-dimensional model from the plurality of aerial images; (3) synthesize a top-down aerial image from the three-dimensional model; and (4) capture the top-down aerial image, forming an improved orthophoto image.

The memory 204 and/or memory 301 may be a volatile memory or a non-volatile memory. The memory 204 and/or memory 301 may include one or more of a read only memory (ROM), random access memory (RAM), a flash memory, an electronic erasable program read only memory (EEPROM), or other type of memory. The memory 204 and/or memory 301 may be removable from the mobile device 122, such as a secure digital (SD) memory card.

The communication interface 205 and/or communication interface 305 may include any operable connection. An operable connection may be one in which signals, physical communications, and/or logical communications may be sent and/or received. An operable connection may include a physical interface, an electrical interface, and/or a data interface. The communication interface 205 and/or communication interface 305 provides for wireless and/or wired communications in any now known or later developed format.

In the above described embodiments, the network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

While the non-transitory computer-readable medium is described to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term “circuitry” or “circuit” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., E PROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A method comprising:
receiving, using a processor, a plurality of aerial images;
developing a three-dimensional model from the plurality of aerial images; and
synthesizing an improved orthophoto image from the three-dimensional model.

2. The method of claim 1, further comprising storing the improved orthophoto image on a personal computer as a reference platform.

3. The method of claim 1, further comprising applying the improved orthophoto image to at least one additional data source, thereby improving the spatial alignment in the at least one additional data source.

4. The method of claim 3, wherein the at least one additional data source is a digital map platform.

5. The method of claim 3, wherein the at least one additional data source comprises a plurality of data sources.

6. The method of claim 1, wherein the plurality of aerial images has been captured by a plane having a plurality of cameras, with one camera of the plurality of cameras arranged to capture a top-down aerial image.

7. The method of claim 6, wherein the three-dimensional model is developed through texture mapping, wherein image data from the one camera arranged to capture the top-down aerial image is primarily used in the texture mapping.

8. The method of claim 1, wherein the improved orthophoto image has a pixel resolution of 20 cm² or less per pixel.

9. The method of claim 1, wherein the synthesizing comprises using an application programming interface.

10. The method of claim 9, wherein the application programming interface is OpenGL.

11. A method comprising:
receiving, using a processor, a plurality of aerial images, wherein the plurality of aerial images has been captured by a plane having a plurality of cameras, with one camera of the plurality of cameras arranged to capture a top-down aerial image;
developing a three-dimensional model from the plurality of aerial images, wherein the three-dimensional model is developed through texture mapping, wherein image data from the one camera arranged to capture the top-down aerial image is primarily used in the texture mapping;
synthesizing an improved orthophoto image from the three-dimensional model through a matrix transformation of the three-dimensional model using OpenGL, the improved orthophoto image having a pixel resolution between 1 cm²/pixel and 20 cm²/pixel; and
applying the improved orthophoto image to at least one additional data source, thereby improving the spatial alignment in the at least one additional data source.

12. An apparatus comprising:
at least one processor; and
at least one memory including computer program code for one or more programs;
the at least one memory and the computer program code configured to, with the at least one processor, cause the apparatus to at least perform:
receive a plurality of aerial images;
develop a three-dimensional model from the plurality of aerial images;
synthesize an improved orthophoto image from the three-dimensional model.

13. The apparatus of claim 12, wherein the at least one memory and the computer program code are configured to cause the apparatus to further perform:
store the improved orthophoto image on a personal computer as a reference platform.

14. The apparatus of claim 12, wherein the at least one memory and the computer program code are configured to cause the apparatus to further perform:
apply the improved orthophoto image to at least one additional data source, thereby improving the spatial alignment in the at least one additional data source.

15. The apparatus of claim 14, wherein the at least one additional data source is a digital map platform.

16. The apparatus of claim 14, wherein the at least one additional data source comprises a plurality of data sources.

17. The apparatus of claim 12, wherein the improved orthophoto image has a pixel resolution of 20 cm² or less per pixel.

18. The apparatus of claim 12, wherein an application programming interface is used to synthesize the top-down aerial image.

19. The apparatus of claim 18, wherein the application programming interface is OpenGL.

20. The apparatus of claim 12, wherein the plurality of aerial images has been captured by a plane having a plurality of cameras, with one camera of the plurality of cameras arranged to capture a top-down aerial image, and
wherein the three-dimensional model is developed through texture mapping, wherein image data from the one camera arranged to capture the top-down aerial image is primarily used in the texture mapping.
